(19) United States
(12) Patent Application Publication
(10) Pub. No.: US 2007/0137563 A1
(43) Pub. Date: Jun. 21, 2007

(54) Curtain coater and curtain coating method

(76) Inventors: Peter Schweizer, Wunnewil (CH); Ferdinand Krebs, Wabern (CH); Marcel Koestinger, Tentlingen (CH)

Correspondence Address: RATNERPRESTIA, P O BOX 980, VALLEY FORGE, PA, 19482-0980, US

(21) Appl. No.: 10/562,340

(22) PCT Filed: Mar. 31, 2005
(86) PCT No.: PCT/EP05/03375

§ 371 Date: Feb. 21, 2007

(30) Foreign Application Priority Data
Apr. 6, 2004 (DE) 10 2004 016 923.3

(51) Int. Cl. B05D 1/30; B05C 3/02

(52) U.S. Cl. 118/411; 427/420; 118/412

(57) ABSTRACT

A curtain coating device for the coating of a moving substrate, comprising a nozzle device, for the generation of a curtain dropping onto the substrate, made up of at least one coating fluid and a curtain guide structure with a guide surface, which laterally guides the curtain, whereby the guide surface is convex to the curtain along a width exceeding the depth of the curtain when measured transversely. Additionally, a curtain coating method, whereby a curtain made up of at least one coating fluid is deposited on a moving substrate in free fall and guided on both sides by means of a convex guide surface transverse to the curtain.

This application is the U.S. national phase application of PCT International Application No. PCT/EP2005/003375, filed Mar. 31, 2005, and claims priority to German Patent Application No. 10 2004 016 923.3, filed on Apr. 6, 2004.

### BACKGROUND OF THE INVENTION

1. Technical Field.

The invention relates to a device and a method for curtain coating a substrate which is moved, preferably a flexible, continuously conveyed web.

2. Description of the Related Art.

Curtain coating is one of many methods for coating flexible, continuous webs with a thin fluid film. The method is suitable for applying a coat of a single fluid or a number of coats of various fluids at the same time. The curtain coating method has been known and researched for many years. A detailed description is provided for example by Miyamoto and Katagiri, Curtain Coating, in Liquid Film Coating, Chapter 11c, Chapman & Hall, New York 1997. In industrial applications, the curtain is either wider or narrower than the web to be coated. If a fluid curtain is not guided laterally along its line of fall, it contracts as a consequence of surface tension forces. Thus, control over the curtain width and therefore also over the pouring width at the point where the curtain impacts the web to be coated is lost. For these reasons, a curtain which is not guided is at most of interest in industrial applications when the curtain is substantially wider than the web to be coated and consists only of a single fluid. In this case, the excess fluid can be captured and reused. In all other applications, in particular when the curtain consists of a number of coats of fluid, it is expedient to guide the curtain vertically on both sides, in order to keep the curtain width constant and the loss of fluid low. A boundary system is advantageous for guided fluid curtains.

A stable fluid curtain is a prerequisite for successfully applying the curtain coating method. A stable curtain is characterized by robustness against internal and external interferences, i.e. interferences cannot permanently destroy it. Theoretical and experimental studies of the stability of fluid curtains are to be found for example in Brown, D. R., 1961, A study of the behavior of a thin sheet of moving liquid, Journal of Fluid Mechanics 10, pages 297-305 and Taylor, G. I. 1959, The dynamics of thin sheets of fluid, part III: Disintegration of fluid sheets, Proceedings of the Royal Society London A, pages 253-313. According to these studies, the fall velocity Vᵥ of a fluid curtain can be calculated according to the following equation:
Vᵥ²=V₀²+2g[x−x₀] (1)

V₀ is the initial velocity of the curtain, dependent on the shape of the nozzle for generating the curtain, preferably a slit nozzle or cascade nozzle; g is the acceleration due to gravity; x is the path coordinate in the direction of fall of the curtain, wherein the origin of the coordinate system is the origin location of the curtain, for example the nozzle lip of a cascade nozzle. x₀ is a measure of the extent of the transition zone within which the initial velocity V₀ transitions into the free-fall velocity. Estimates of the order of magnitude of the individual terms in Equation (1) show that V₀ and x₀ are negligible for engineering considerations. The fall velocity of the fluid curtain can therefore be approximately calculated using Equation (2):
Vᵥ=\sqrt{2gx} (2)

On the other hand, punctiform interferences in a fluid curtain have been found to spread radially at a velocity Vₛ according to the following equation:

$${V}_{S} = \sqrt{\frac{2 σ}{ρ {H}_{V}}} \qquad ( 3 )$$

σ is the surface tension of the fluid, ρ is the fluid density and Hᵥ is the thickness of the curtain.

On the basis of the above findings, Brown has defined the following stability criterion for fluid curtains:
Vᵥ>Vₛ (4)

The curtain is stable if the fall velocity is greater than the spreading velocity of interferences in the curtain. Given this condition, interferences cannot spread counter to the downward-directed falling movement, but are washed away downwards and can therefore tear the curtain at most locally and temporarily, but not disastrously.

The stability criterion (4) is also known in the following dimensionless form:

$$We = \frac{ρ {QV}_{V}}{σ} > 2 \qquad ( 5 )$$

The dimensionless Weber number We is a measure of the ratio of inertial forces to surface tension forces acting in the fluid curtain.

On the basis of Equations (4) and (5), it can be deduced that the stability of fluid curtains is promoted by: long curtains; thick curtains; low surface tension of the fluid; high density of the fluid; high fall velocity; and a high volume flow. In the same way, it can be deduced that curtain stability is threatened or even lost if the current in the curtain does not exhibit the above properties. Curtain stability is even threatened if the above properties are even only locally absent, for example along a curtain side guide.

A slit nozzle or cascade nozzle, as by way of example described by Miyamoto and Katagiri, can in particular be used to form a fluid curtain. When using a slit nozzle, the curtain is formed directly at the outlet of the nozzle slit. When using a cascade nozzle, by contrast, the fluid—once it has exited the nozzle slit—first flows on the nozzle surface as far as the nozzle lip, in the form of a single-coat or multiple-coat fluid film. Only at the nozzle lip is the film current transformed into a curtain current. In order that the film current remains well-defined in its width on the nozzle surface, it should be guided laterally by means of a nozzle side boundary. If a fluid with a free surface is laterally restricted by a wall, the wetting line is located—depending on the wetting properties between the fluid and the wall material as a consequence of capillary forces—either above the fluid surface if well wet, or below the fluid surface if poorly wet, as described for example in Weinstein, S. J. and Palmer, A. J., Capillary hydrodynamics and interfacial phenomena, Chapter 2, in Liquid Film Coating, Chapman & Hall, New York 1997. The shape of the fluid surface is therefore altered along the boundary. The changes can be particularly significant if the fluid flows along the side boundary. This is shown for example by Schweizer, P. M., 1988, Visualisation of coating flows, Journal of Fluid Mechanics 193, pages 285-302.

Nozzle side boundaries are described for example in DE 30 37 612 C2 and WO 94/08272. WO 94/08272 suggests that on its downstream edge, at which the film current of the nozzle surface also transitions into the curtain current, the nozzle side boundary should have the same height, measured to the nozzle surface, as the free film current. Between its upstream section and its downstream edge, the nozzle side boundary comprises a short transition section in which its height, measured to the nozzle surface, is reduced towards the downstream edge, in the form of a simple slant.

The falling curve of the curtain is significantly dependent on the type of nozzle used to generate the curtain. If a slit nozzle is used, then the curtain falls substantially vertically in the elongation of the nozzle slit, in particular if the curtain consists of a single fluid. If, by contrast, a cascade nozzle is used to generate the curtain, then an asymmetrical current field results in the vicinity of the nozzle lip and causes the falling curve of the curtain to be deflected from the vertical. In particular, the curtain curves backwards below the nozzle lip, referred to as the “tea-pot effect” (Kistler, S. F. and Scriven, L. E., 1994, The tea-pot effect: sheet forming flows with deflection, wetting and hysteresis, Journal of Fluid Mechanics 263, pages 19-62). This effect should be taken into account when configuring the curtain side boundary. If a rod-shaped, i.e. lineal side boundary is used, then significant distortions result in the peripheral zone of the curtain when the tea-pot effect is pronounced, which adversely affects the stability of the curtain since the geometric shape of the side boundary does not match the natural shape of the falling curve of the curtain. If, by contrast, plates are used as the side boundary, as is disclosed in EP 0 907 103 B1, then the interfering peripheral effects are lower since the curtain can retain its natural falling curve along the side boundary.

The actual coating occurs where the curtain impacts the substrate which is moved. The aim of coating is for the curtain fluid to completely and uniformly displace the air which is in contact with the uncoated substrate. In cross-section, the current field in the curtain impact zone looks like the heel of a foot, wherein the dynamic wetting line is where the heel contacts the substrate. In order that the substrate is coated uniformly, crossways to the substrate, and that air pockets between the substrate and the impacting curtain fluid are avoided, the current field of the curtain impact zone should have an ideal shape, i.e. the curtain heel should have an ideal size. The pulse of the impacting curtain should also be above a minimum value, in order that air pockets can be avoided. Criteria for an optimum heel size are formulated for example by Blake et al., 1994, Hydrodynamic assist of dynamic wetting, AIChE Journal 40 (2), pages 229-242 and Schweizer, P. M., Control and optimization of coating processes, in Liquid Film Coating, chapter 15, Chapman & Hall, New York 1997. According to these criteria, the location of the dynamic wetting line is ideally in the area of the rear face of the curtain. The location of the dynamic wetting line can be approximately calculated with the aid of border coat theory and depends on a number of parameters relevant to the method, and in particular on the impact velocity of the curtain. It is therefore advantageous if the curtain side boundary is configured such that the curtain fluid impacts the substrate at the same velocity at each location crossways to the conveying direction of the substrate. The peripheral effect of the delay due to friction should in particular be reduced as far as possible.

In order to avoid friction effects at the periphery of the curtain, U.S. Pat. No. 5,395,660 for example suggests wetting the side boundary with a low-viscosity auxiliary fluid which forms a border coat on the side boundary and thus separates the curtain fluid from the side boundary. The separating coat of this auxiliary fluid acts as a lubricating film. The auxiliary fluid is captured and sucked away by means of a separating and suction means in the vicinity of the substrate. Lubricating is optimized according to EP 0 907 103 by supplying the auxiliary fluid to the side boundary such that it has the same velocity as the curtain fluid throughout the area of its side which faces the curtain, away from the side boundary. This avoids braking effects in the curtain itself. However, in order to adapt the fall velocity of the auxiliary fluid to the fall velocity of the curtain, a large volume flow of the auxiliary fluid is required. A further negative consequence of the large volume flow is that the film current of the auxiliary fluid becomes unstable along the curtain side boundary and forms waves, which in turn adversely affects the stability of the curtain. On the other hand, the geometric configuration of the tear-off edge and the operation of a suction slit at the lower end of the curtain side boundary mean that not all of the auxiliary and peripheral fluid can be sucked away. As a consequence, and depending on the specific operational conditions, a peripheral zone is formed in the curtain impact zone, in which the coating conditions are worse than in the centre of the curtain. In particular, the peripheral zone often draws air in, even at lower substrate velocities than in the centre of the curtain. It is also observed that, when the tea-pot effect is significant, the curtain is moved so far backwards that it leaves the plate-shaped side boundary, which in turn adversely compromises curtain stability. This situation occurs particularly often with long curtains over about 150 mm. While widening the plate-shaped side boundary would allow even significantly deflected curtains to still be held over large falling heights, new problems would however result on the lower end of the side boundary in the form of large peripheral bulges on the coated web, particularly when the curtain impacts not a horizontal substrate but a curved substrate supported by a counter roller. Lastly, it has been observed that the side boundary of EP 0 907 103 B1—depending on operational conditions—produces peripheries which are not geometrically well-defined but frayed and excessively thick, and which often cannot be dried and create problems in the form of telescoping when winding coated substrates formed as webs. The reason for these problems is the geometric configuration of the underside of the curtain side boundary. In particular, a narrow conical gap results between the underside and the web to be coated. If fluid enters this gap, for example when starting up the pouring process, the fluid is held fast in the gap by capillary forces, thus causing the poor peripheries.

### SUMMARY OF THE INVENTION

It is an object of the invention to reduce peripheral effects which adversely affect the coating result.

In particular, it is an object to provide a side guide for a fluid curtain which more exactly determines the line of fall of the curtain as compared to a plate-shaped side guide, but which nonetheless keeps tension forces in the curtain low. Border coat effects should be reduced.

The invention relates to a curtain coater for coating a substrate which is moved, preferably a flexible, continuously conveyed web. The curtain coater comprises a nozzle device, preferably a cascade nozzle or slit nozzle, for generating a curtain which falls onto the substrate, and a curtain guiding structure comprising a guiding face which guides the curtain along one of its two sides. The nozzle device can in particular be constructed such that it can form a multiple-coat curtain.

According to the invention, the guiding face is convex to the curtain over a width which, measured crossways to the curtain, substantially exceeds the curtain thickness. The side guide is accordingly not lineal as it is formed by a thin rod. It advantageously extends in height to as near as possible to the nozzle lip, ideally as far as the nozzle lip, and extends in the opposite direction to as near as possible to the substrate, wherein in preferred embodiments, a distance still remains between the guiding face and the substrate which is sufficient for arranging a capturing means for an auxiliary fluid which forms a lubricating film on the guiding face, and a suction means for sucking away the auxiliary fluid. A curtain guiding structure comprising a guiding face according to the invention is preferably provided on both sides of the curtain. Due to its convex shape, the guiding face—as viewed crossways to the curtain—comprises a central protruding area, and on both sides of the central area, side areas which are receded with respect to it. If interference forces act on the curtain, for example due to air currents or due to the tea-pot effect, the curtain current tends to remain in the central area of the guiding face or to move in the direction of the central area, in order to minimize its surface tension forces. The guiding face thus predefines a local state of equilibrium throughout the curtain, from which it can be deflected due to interferences, but wherein it is still constantly bound to the guiding face, and to which it naturally tends to return due to the tension forces which are increased when the curtain is deflected. Since, on the other hand, the curtain can migrate along the guiding face, crossways to the face of the curtain, the tension forces generated by this in the curtain are smaller than with a rod-shaped, i.e. lineal side guide which does not allow the curtain to give at its periphery due to the effect of interference forces.

The contour of the guiding face is continuous, i.e. constant, over its entire width, such that when the curtain is deflected, its tension forces do not change abruptly but only gradually in accordance with the course of the contour. Although the convexity of the guiding face can also be achieved by means of a contour comprised of straight lines with preferably smooth transitions, it is preferable for the guiding face to be curved throughout, crossways to the curtain, i.e. in horizontal sections. The curvature radius of the guiding face should be constantly differentiable throughout, over its entire width. This requirement is fulfilled in particular by a cylinder face. A circumferential segment of a circular cylinder face is a particularly simple and not least therefore preferred guiding face. The curvature radius of the guiding face should measure at least 5 mm and at most 50 mm, wherein this is to apply to all horizontal sections of the curtain guiding structure for the curvature radius which is preferably constant throughout, but also in the case of a variable curvature radius.

In one development of the invention, a border coat film of an auxiliary fluid is formed over the entire guiding face and separates the curtain fluid from the guiding face and preferably exhibits the local fall velocity of the curtain over the falling height of the curtain, at least on its outer side facing the curtain. Reference is made to EP 0 907 103 B1 with respect to forming the lubricating film, the teaching of which for forming the border coat film can be transferred onto the shape of the guiding face in accordance with the invention.

The curtain guiding structure is preferably a hollow profile with a hollow space and a shell which surrounds the hollow space, forms the guiding face on an outer surface and preferably exhibits a uniform permeability to the auxiliary fluid over the entire guiding face. While the permeability can also be achieved inter alia by mechanically drilling or laser-treating an otherwise impermeable material, the curtain guiding structure is however more preferably produced from a porous material having an open porosity, at least in its area forming the guiding face. The hollow profile can be in multiple parts, wherein the guiding face forms a wall part of the hollow profile, but is preferably formed in one part as a pipe, preferably as a pipe which is porous throughout. If the hollow profile is permeable to the auxiliary fluid over its entire circumference, it is preferable for it to be sealed in its circumferential segment outside the guiding face, preferably on its outer surface, in order to keep the volume flow of the auxiliary fluid low.

In order to be able to set its position optimally, the guiding face is preferably supported such that it can be moved with respect to its position relative to the nozzle device and the substrate.

Mobility should be provided at least crossways to the conveying direction of the substrate for the purpose of adjusting the width of the curtain. Mobility for adjusting the height of the guiding face is likewise advantageous. Lastly, an adjustment in and counter to the conveying direction of the substrate is also advantageous.

Additionally or instead, it can also be advantageous if the guiding face can be inclined to the vertical by a small angle, in order for example to be able to vary—preferably, to reduce—the width of the curtain in the direction of fall, and/or to hit the desired impact location on the substrate exactly despite a tea-pot effect. Instead of or in addition to a purely translational adjustability, a rotational adjustability is thus likewise advantageous. The guiding face, preferably the curtain guiding structure, is advantageously supported adjustably, for setting on a coordinate table in accordance with its possible adjustment(s).

In a further development, the current ratios in the coating fluid or in the multiple-coat coating fluids are improved not only in the peripheral zone of the curtain current but also in the peripheral zone of the film current of the nozzle device. The improvement is aimed at nozzle devices which comprise a nozzle surface inclined to the horizontal, an exit opening through which the coating fluid of the nozzle surface can be supplied such that the coating fluid forms a downward-flowing film current on the nozzle surface, also a nozzle lip which forms a downstream end of the nozzle surface at which the film current transitions into the curtain current, and lastly a nozzle side boundary for laterally restricting the film current flowing on the nozzle surface. According to the invention, the nozzle side boundary exhibits throughout—from the nozzle lip as far as a point upstream of the nozzle lip—a height, measured to the nozzle surface, which at least substantially, preferably precisely, corresponds to the respectively local thickness of the free film current outside the border coat on the side boundary. Adapting the boundary height to the thickness of the free film current, which changes in its course, i.e. to its equilibrium thickness, causes the film current to neither flow over the nozzle side boundary nor be drawn up it due to capillary action. This can reduce flows of material crossways to the current direction pointing to the nozzle lip.

The longitudinal section of the nozzle side boundary, which is adapted in this way to the thickness of the free film current, preferably extends at least as far as the exit opening. If a number of exit openings are provided in succession in the current direction, for forming a multiple-coat film current, the longitudinal section of the nozzle side boundary adapted in height in this way should extend as far as the most upstream point at which one coat flows onto the next, preferably as far as the most upstream of the exit openings. The less the film current on the nozzle surface is interfered with along the nozzle side boundary, and the less the thickness of the fluid film is therefore non-uniform along the nozzle side boundary due to capillary effects, the more uniformly the fluid curtain formed below the nozzle lip can be set.

The upper periphery of the nozzle side boundary is advantageously formed in the form of an edge. Movements of a wetting line along a solid surface can then be inhibited if the wetting line adheres to an edge, wherein the inhibiting effect increases as the angle decreases. This effect is described for example by Oliver, J. F. et al., 1977, Resistance to spreading of liquids by sharp edges, Journal of Colloid and Interface Science 59 (3), pages 568-581. The edge is ideally a knife blade. This minimally interferes with the peripheral area of the film current, which has an optimally favorable effect on the stability of the subsequent curtain current. Forming the edge as a knife blade is however not possible for reasons of mechanical stability and operational safety and/or risk of injury. As a compromise, the enclosed edge angle should be selected from the range of 30° to 90°. Edge angles smaller than 80° or smaller than 70° are preferred. By shaping the upper periphery of the nozzle side boundary as an acute-angled edge, it is possible to deviate within certain limits from the ideal of a height of the nozzle side wall boundary which is adapted exactly to the free film current, as long as the wetting line also adheres to the edge when the height of the side boundary deviates from the thickness of the fluid film.

In another further development of the nozzle device, which advantageously cooperates together with adapting the height and/or edging the upper periphery of the nozzle side wall boundary but is also advantageous even on its own, the nozzle device comprises a fluid supply for wetting the nozzle side boundary at least in sections with an auxiliary fluid acting as a lubricant, in order to form a lubricating film in at least one longitudinal section of the nozzle side boundary, said lubricating film separating the film current of the coating fluid or the number of coating fluids from the nozzle side boundary. The surface tension of the auxiliary fluid should be greater than the surface tension of the coating fluid or, in the case of a number of different coating fluids, greater than the highest surface tension of the coating fluids. The nozzle side boundary can in particular be formed to be permeable to the auxiliary fluid in a wall section, preferably by means of a porous material forming the wall in said section. The shape of the fluid-permeable wall area is determined according to the proportions provided for the shape of the nozzle side boundary.

Although each of the aspects discussed above, namely the side guide for the curtain and the number of embodiments of the side boundary of the nozzle device, are each advantageous in their own right, a number of these aspects—advantageously, all the aspects—should be realized together and coordinated in a device and/or method for curtain coating, in order to optimize the coating result. Although the various further developments of the nozzle device are subsumed by the side guide of the fluid curtain in accordance with the invention, each of the further developments of the nozzle device, in its own right, can be advantageously combined with other curtain side guides and are also advantageous even without a curtain side guide.

### BRIEF DESCRIPTION OF THE DRAWINGS

Example embodiments of the invention are explained below on the basis of figures. Features disclosed by the example embodiments, each individually and in any combination of features, advantageously develop the subjects of the claims and the embodiments described above. There is shown:

FIG. 1 a curtain coater, comprising a nozzle device formed as a slit nozzle;

FIG. 2 a curtain coater, comprising a nozzle device formed as a cascade nozzle;

FIG. 3 the nozzle device of FIG. 2, in a section parallel to the current;

FIG. 4 the nozzle device of FIG. 3, in a section crossways to the current direction;

FIG. 5 a modified nozzle device, in a section parallel to the current;

FIG. 6 the nozzle device of FIG. 5, in a section crossways to the current direction;

FIG. 7 a curtain side guide;

FIG. 8 a cross-section through the curtain side guide;

FIG. 9 depositing a free-falling fluid curtain on a substrate;

FIG. 10 the curtain side guide, comprising a separating and suction means, in a vertical section;

FIG. 11 a suction device for sucking away a periphery of the coating deposited on the substrate, in a vertical section; and

FIG. 12 the suction device of FIG. 11, in a top view onto the substrate.

### DETAILED DESCRIPTION OF THE INVENTION

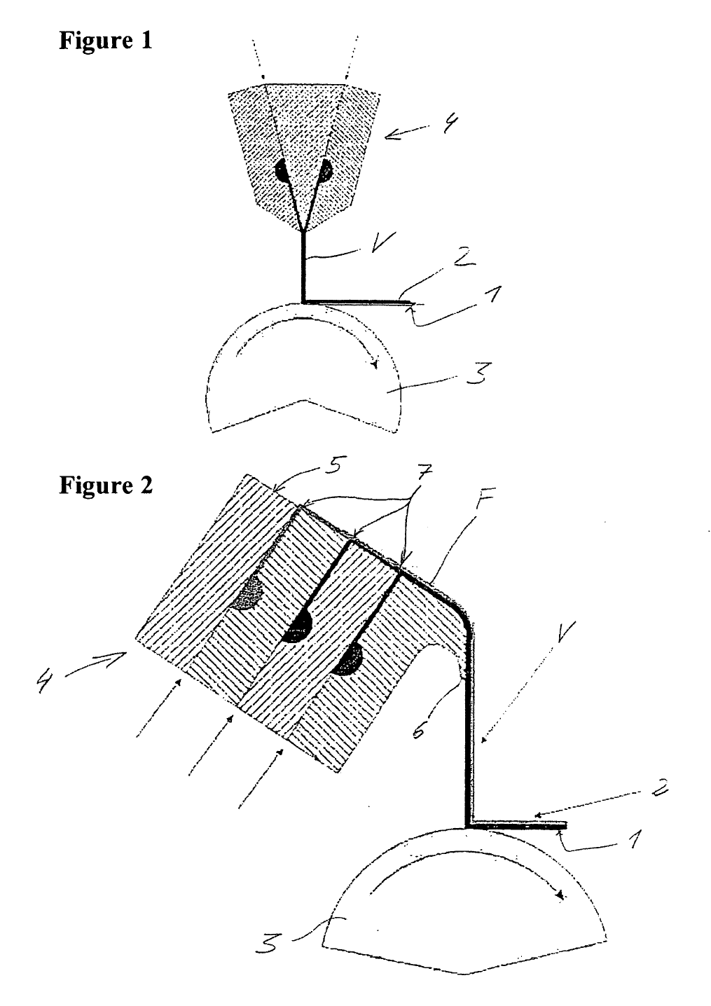

FIG. 1 shows a curtain coater comprising a nozzle device 4 arranged vertically above a roller 3 at a clear distance. The roller 3 serves as a deflection means or, in more general terms, as a supporting means for a substrate 1 to be coated, which is conveyed via the roller 3, which it wraps around. The substrate 1 is a continuously conveyed, flexible web. The nozzle device 4 is a slit nozzle in which separate supplies are formed for a number of—in the example embodiment, two—different coating fluids. The supplies converge in a nozzle exit opening at a lower end of the nozzle device 4 facing the substrate 1. The exit opening extends slit-shaped, crossways to the conveying direction of the substrate 1, over a width which is greater than the target coating width of the product formed from the substrate 1 and the coating 2. In principle, however, the width of such an exit opening can also be smaller than the target coating width. The two coating fluids leave the exit opening of the nozzle device 4 in free-fall as a two-coat fluid curtain V. The nozzle device 4 is arranged relative to the roller 3 such that the curtain V spans a vertical plane with a rotational axis of the roller 3 if the curtain V is not interfered with.

FIG. 2 shows a curtain coater comprising a nozzle device 4 formed as a cascade nozzle. It comprises a nozzle surface 5 which is inclined to the horizontal such that a coating fluid supplied to the nozzle surface 5 flows downwards on the nozzle surface 5 as far as a nozzle lip 6 forming the downstream end of the nozzle surface 5 and, flowing beyond the nozzle lip 6, transitions into the free-falling curtain V. A number of different coating fluids are supplied to the nozzle surface 5 via exit openings 7 in accordance with the number of exit openings 7, and form a multiple-coat film current F on the nozzle surface 5 in a known way, said film current F flowing off via the nozzle lip 6 into the curtain V. The exit openings 7 are slit-shaped and extend crossways over the width of the nozzle surface 5. The upstream section of the nozzle surface 5 extending over the exit openings 7 is planar, i.e. forms an oblique plane. The nozzle surface 5 is curved in a subsequent downstream section, wherein its inclination gradually increases in order to provide a continuous transition to the downstream end of the nozzle lip 6.

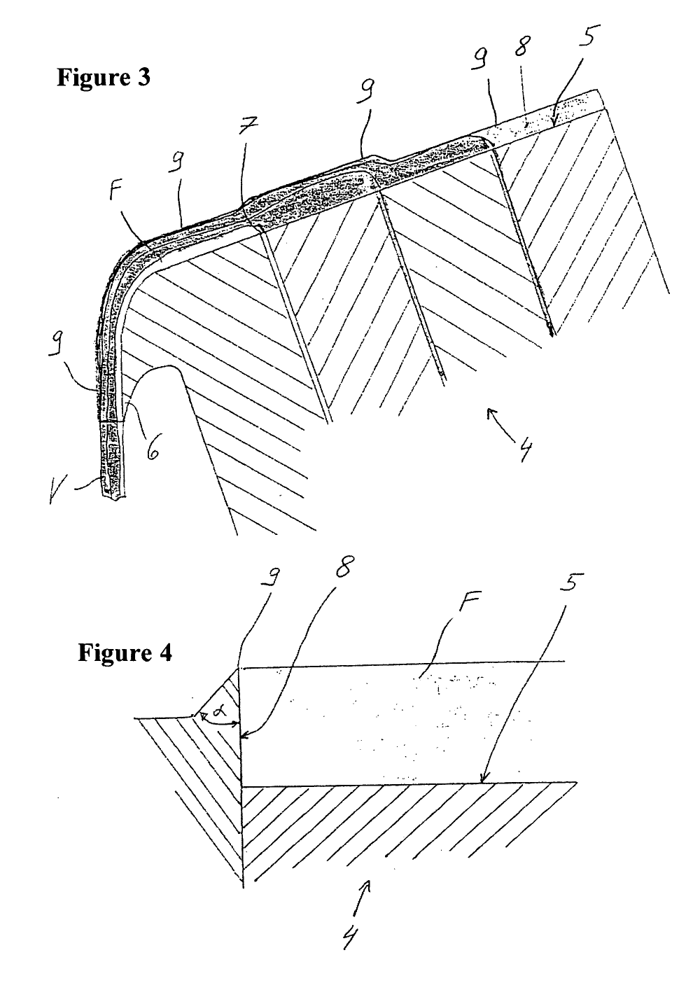

FIG. 3 shows the nozzle device 4 of FIG. 2 in a vertical section, with a view onto a side boundary 8 of the nozzle surface 5. The side boundary 8 extends parallel to the current direction of the free film current and restricts it in the crossways direction. An identical side boundary 8 restricts the film current F at its other periphery. The side boundary 8 extends from the downstream end of the nozzle lip 6 as far as the most upstream exit opening 7 and, in the example embodiment, slightly beyond. It exhibits throughout a height, measured to the nozzle surface 5, which corresponds to the thickness of the free film current, respectively measured to the same current height, in the central area between the two side boundaries 8. Due to this adapted height, the film current F exhibits at least substantially the same, and therefore uniform thickness at each current height over its entire width, i.e. also in its two peripheral areas.

The thickness of the film current F depends not only on the angle of inclination of the nozzle surface 5 but also on the density, the viscosity and the ratio of volume flow to width of the film current F. In the case of multiple-coat films, the density, viscosity and volume flow/width of each of the fluids forming the film have to be taken into account. Known analytical formulae can be used to calculate the thickness of single-coat and two-coat film currents, wherein the viscosity is taken at the locally prevailing, mostly low shear rates. Numerical methods for calculating the local thickness of the film current F are used for film currents of three and more coats.

Since the angle of inclination of the nozzle surface 5 changes from typically 15° to 30° in the upstream section to typically 90° in the downstream section, the thickness of the film current F also changes correspondingly. In the case of multiple-coat films F, the coat thickness also changes between adjacent exit openings 7 in the upstream section of the nozzle surface 5, even if the angle of inclination is constant there. In particular, the side boundary 8 is adapted to the thickness of the free film current F over the downstream section of the nozzle surface 5, in the way described. The height of the boundary 8 is advantageously also adapted in the same way, in the upstream section of the nozzle surface 5 comprising the exit openings 7, to the local thickness of the free film current in said section, by changing the height of the side boundary 8 in said section, advantageously in the areas in which a coat already flowing down the nozzle surface 5 flows onto the next coat. As indicated in the example embodiment, it is then sufficient if the height of the side boundary 8 changes in steps at each of the corresponding points and remains constant between them. In the downstream section in which the nozzle surface 5 curves more significantly, the height of the side boundary 8 should change such that it is adapted as closely as possible to the thickness of the free film current F and is thus constantly differentiable.

FIG. 4 shows the nozzle device 4 of FIG. 3 in a section crossways to the current direction of the free film current F in the downstream section of the side boundary 8 and the nozzle surface 5. The side boundary 8 forms an acute-angled edge 9 as the upper periphery. In particular, it forms the acute-angled edge 9 in its downstream section which extends as far as the downstream end of the nozzle lip 6. It preferably forms an acute-angled edge 9 at its upper periphery over the entire length of the downstream section, particularly preferably over its entire length which laterally restricts the film current F. The inner wall facing the film current F and an upper part of the outer surface of the side boundary 8 meet at the edge 9, enclosing an acute edge angle a. The smaller the enclosed angle a, the better the static wetting line of the film current F adheres to the edge 9. In particular, the wetting line also adheres to the edge 9 when the height of the side boundary 8 does not exactly match the thickness of the free film current F. As a compromise between strong edge adhesion on the one hand and sufficient mechanical stability and operational safety on the other hand, the enclosed edge angle a is selected from the range between 30° and 90°, as applicable with an edge angle a which decreases towards the downstream end of the nozzle lip 6 and can even be below the 30° cited at said end. Making the thickness of the film current F uniform at its peripheries is above all advantageous in the area of the nozzle lip 6 and the transition from the film current F into the curtain current V at the downstream end of the nozzle lip 6, in order to incorporate as little interference from the peripheral zone of the film current F as possible into the curtain current V.

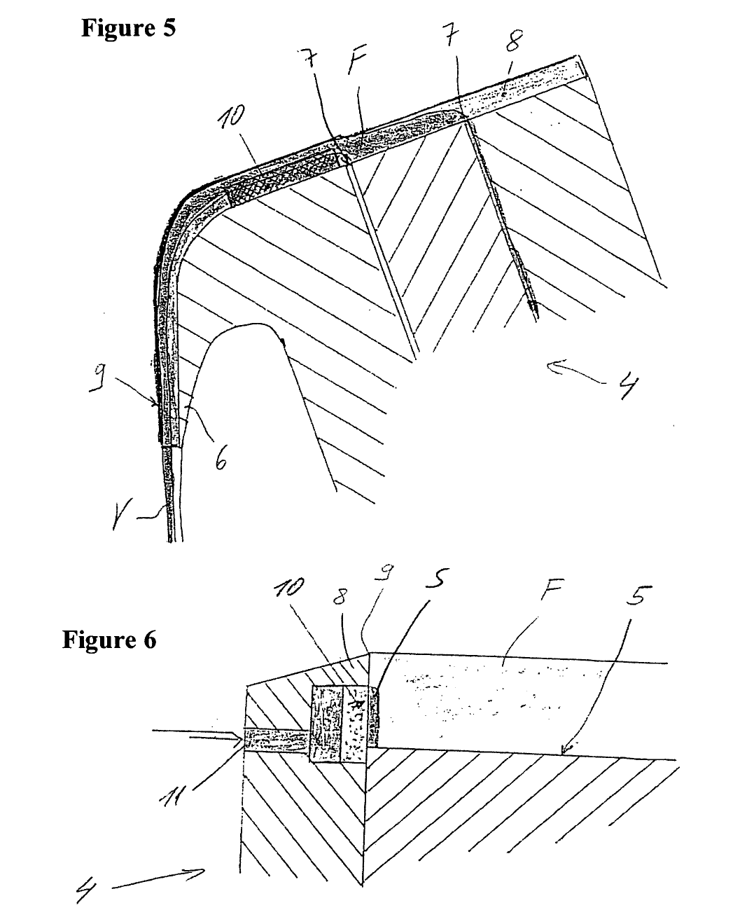

FIGS. 5 and 6 show the side boundary 8 again, in a section parallel to the current direction of the free film current F and in a section crossways to the same. The side boundary 8 of FIGS. 5 and 6 has been developed further as compared to the side boundary 8 of FIGS. 3 and 4 by actively reducing the extent of a viscous border coat along the side boundary 8. Reducing the extent of the border coat is above all advantageous for coating fluids having a high viscosity. The fluid of the film current is braked within the border coat as a consequence of viscosity forces as compared to the equilibrium velocity outside the border coat, i.e. the current velocity of the free film current. The braking effect can cause undesirable interference if the border coat fluid flows into the curtain V. The border coat thickness along the side boundary 8 of the film current F and crossways to the current direction of the free film current F is reduced by introducing a thin film S of a low-viscosity fluid acting as a lubricant, between the fluid of the film current F and the side boundary 8. Such a lubricating film S is generated by forming at least one longitudinal section of the side boundary 8 as a porous wall through which the supplied auxiliary fluid flows, exits on the inner wall of the side boundary 8 and forms a thin border coat itself.

The porous wall is formed by a porous wall structure 10, formed in the example embodiment as a plate, which is inserted into the side boundary 8. The porous wall structure 10 extends downwards as far as the nozzle surface 5, in the example embodiment even beyond the nozzle surface, but does not form the upper periphery of the side boundary 8 which is again formed as an acute-angled edge 9. If the side boundary 8 does not rest on the nozzle surface 5 but is arranged protruding laterally beyond it, as for example shown, the height of the side boundary 8 can also be adjusted comparatively simply. The wall structure 10 should extend at least as far as the height of the nozzle surface 5 in all positions of a height-adjustable side boundary 8. On the inner side which points to the film current F, the wall structure 10 closes flush with the remaining face of the side boundary 8. A fluid supply 11 is formed in the side boundary 8 and extends as far as the rear side of the porous wall structure 10 facing away from the film current F, where it expands to form a hollow space covering the entire rear side of the wall structure 10, such that the rear side of the wall structure 10 is uniformly pressurized by the supplied auxiliary fluid. Due to its pressure and the porosity of the wall structure 10, the auxiliary fluid flows through the wall structure 10 and, on its inner face, forms the thin lubricating film S indicated in FIG. 6. Supplying the auxiliary fluid through the permeable wall structure 10 keeps interference by the auxiliary fluid low. A particularly suitable location for forming the lubricating film S is the section of the side boundary 8 between the most downstream of the exit openings 7 and the beginning of the increasing curve of the nozzle surface 5. The wall structure 10 should extend over the entire length of this section. In particular, water is suitable as a low-viscosity auxiliary fluid for aqueous coating fluids and organic solvents are suitable as a low-viscosity auxiliary fluid for fluids consisting of organic components.

The first partial system of the side boundary, formed in the area of the nozzle device 4, is connected to a curtain side guide as a second partial system. The latter extends from the nozzle lip 6 to directly above the substrate 1. The curtain side guide is preferably formed identically on both longitudinal sides of the curtain V, and arranged symmetrically with respect to the curtain.

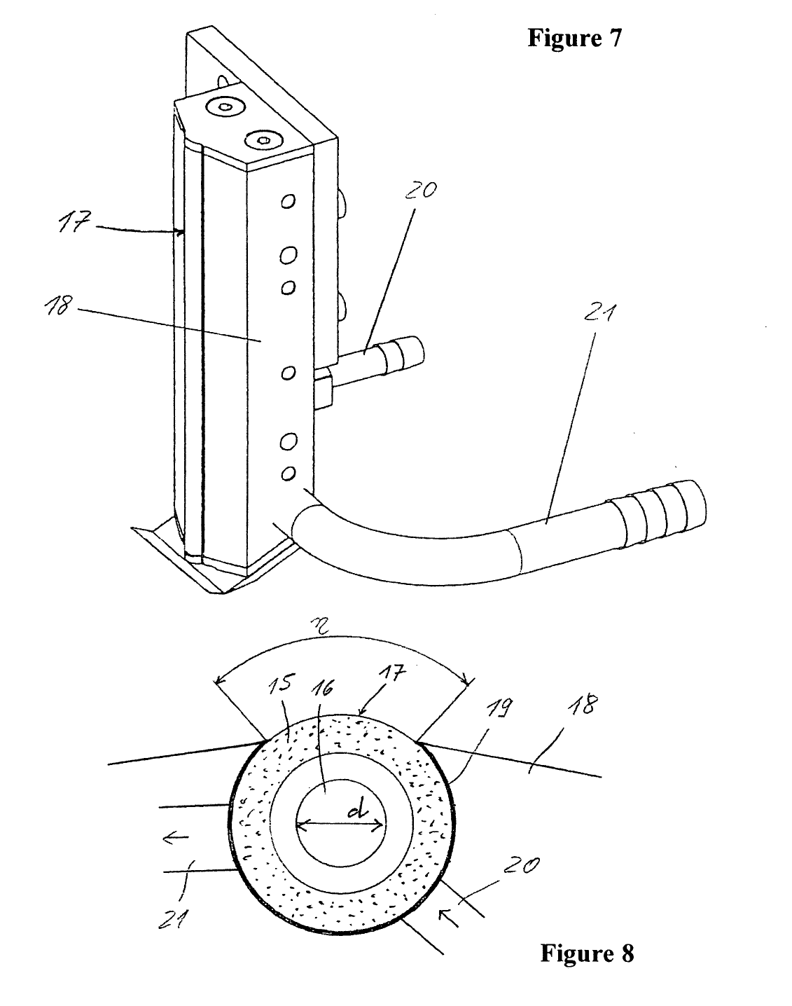

FIG. 7 shows one side of the curtain side guide, detached from the curtain coater. Distanced in the opposite direction over the width of the curtain V, an identical curtain side guide is provided. The curtain side guide forms a guiding face 17 which is convex with respect to the curtain V. The guiding face 17 in the example embodiment, which arches towards the curtain, is circular cylindrical, wherein the cylinder axis points vertically or at least substantially vertically in the curtain coater.

As may be seen in the cross-section of FIG. 8, the guiding face 17 is an elongated circumferential segment of a curtain guiding structure 15 formed as a circular pipe. The curtain guiding structure 15 is fixed in a holder 18, such that only its guiding face 17 protrudes out of the holder 18 towards the periphery of the curtain V. The pipe 15 is entirely porous, i.e. over its entire circumference and its entire length. It exhibits a constant outer diameter which is selected from the range of 10 to 30 mm, depending on the length of the pipe 15. A low-viscosity auxiliary fluid is conveyed into the hollow space 16 enclosed by the pipe shell. For this purpose, the pipe 15 is connected via the holder 18 to a supply 20 for the auxiliary fluid. An outlet 21 for fluid is also indicated. The auxiliary fluid exhibits a surface tension which is greater than the surface tension of the coating fluid and, in the case of a multiple-coat curtain V, is greater than the highest of the surface tensions of the number of coating fluids. Water is suitable as an auxiliary fluid for aqueous coating fluids. Organic solvents are suitable as an auxiliary fluid for coating fluids consisting of organic components.

In order to keep the volume flow of auxiliary fluid low, the pipe 15 is sealed over its entire outer surface outside the guiding face 17, where the auxiliary fluid thus cannot exit. The seal is indicated in FIG. 8 by the reference sign 19. The guiding face 17 extends in a circumferential direction over an angle η which measures less than 180°. The guiding face 17 preferably covers an angle η measuring between 70° and 120°.

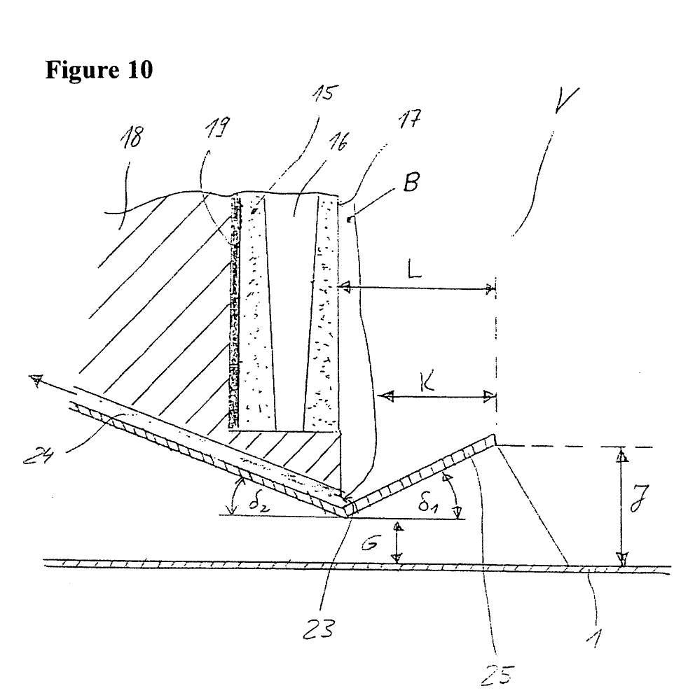

The wall thickness of the pipe 15 varies over its length, i.e. over the height of the curtain V. The variation can be seen in FIG. 8 and better still in FIG. 10. The variation is such that the hollow space 16 forms a cone extending in the longitudinal direction of the pipe 15, having a minimum diameter d at the lower end and a maximum diameter at the upper end of the pipe 15. Calculating suitable wall thicknesses of the pipe 15 is described in EP 0 907 103 B1. The outer diameter of the porous pipe 15 depends on the pipe length or curtain height. It is selected such that the lowest wall thickness measures at least 1 to 3 mm and the lowest diameter of the hollow space 16 measures at least 1 to 3 mm, wherein the value of the lowest wall thickness should be selected to be greater as the brittleness of the porous material increases. The diameter of the hollow space 16 is limited towards the smaller value by the length of pipe 15 if the hollow space 16 is machined from a solid cylinder, for example using a drill and a cutter. A cutter, preferably a beveled cutter, is not as narrow as desired for a given length. The porous pipe 15 can be manufactured from many different materials, as long as the pipe material is compatible with the auxiliary and/or coating fluids. Suitable pipe materials are for example polyethylene, stainless steel and glass.

By varying the wall thickness, a border coat current B of the auxiliary fluid is formed (FIG. 10) which flows down the guiding face 17 and in which the auxiliary fluid has the same velocity or at least substantially the same velocity as the curtain fluid throughout the falling height of the curtain V, such that the curtain current V is not delayed, but also not accelerated, at its two peripheries by being bound to the guiding face 17.

The advantage of the convex guiding face 17 as compared to a planar face as a guiding face is that the curtain V, if its falling curve happens to be deflected, for example due to the tea-pot effect, is constantly guided back along the guiding face 17 to the area—in the case of a constantly curved guiding face 17, point or location—protruding with respect to the curtain V. When the curtain V is deflected, it would have to widen in the direction of fall in order to remain in contact with the guiding face 17, which it does not want to do as a consequence of capillary forces. This avoids the curtain V, when significantly deflected above all in the peripheral zones, impacting the substrate 1 to be coated at an adverse impact location or even leaving the side guide. Using the guiding face 17, the impact zone of the curtain V is therefore determined more precisely than with planar guiding faces, which is in particular advantageous when the substrate 1 to be coated is supported in the area of the impact zone of the curtain V, such that the curtain impact angle depends on the impact location over the surface of the supporting means, for example the roller 3.

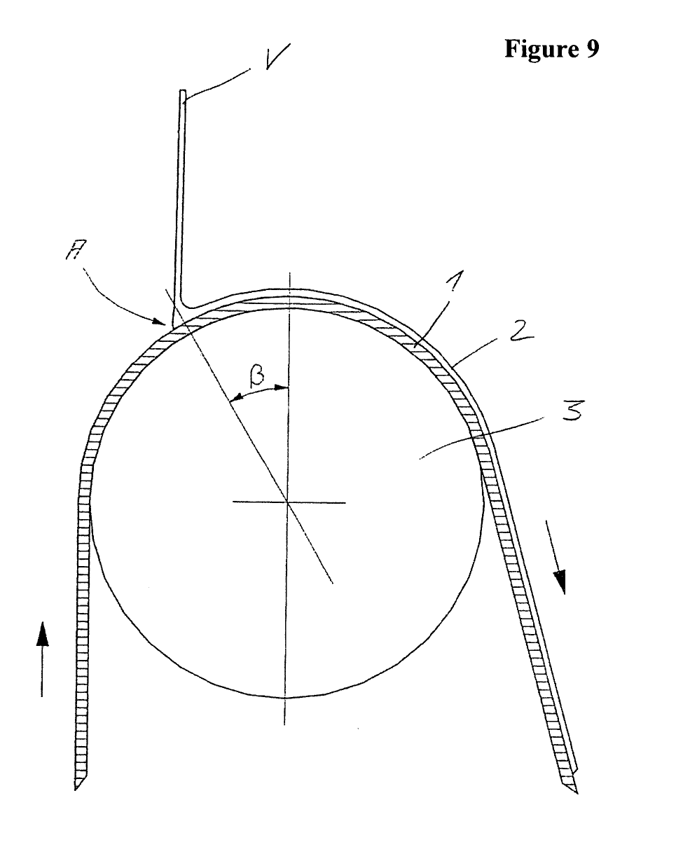

FIG. 9 clarifies these relationships in the area of the impact point A. The angle β determines the location of the impact point A of the curtain V on the substrate supported by the roller 3, with respect to the vertically pointing radial onto the rotational axis of the roller 3. Without the curtain V being guided back by the convex guiding face 17, the angular position of the impact point A, expressed by the positional angle β, would be altered depending on the magnitude of the tea-pot effect and/or other interferences.

In order that the mechanical transition between the nozzle side boundary 8 of the film current F and the guiding face 17 of the curtain current V is continuous, the guiding face 17 or better still the holder 18 should be arranged adjustably. The holder 18 is preferably mounted on a three-dimensional coordinate table. The position of the guiding face 17 can thus be set perfectly, without damaging the nozzle lip 6 while setting. In particular, the adjustable arrangement enables the position of the guiding face 17 to be optimally adapted to the falling curve of the curtain V, should the falling curve deviate significantly from the vertical as a consequence of the tea-pot effect.

The auxiliary fluid, which flows downwards along the guiding face 17, is sucked away at the lower end of the guiding face 17 before it impacts the substrate 1.

FIG. 10 shows the relationships at the lower end of the guiding face 17. A separating means 25 for the auxiliary fluid flowing downwards in the border coat B on the guiding face 17 is arranged vertically below the guiding face 17 and fixed to the holder 18. The separating means 25 is formed as a separating metal sheet and is also referred to as such in the following. The lower end of the guiding face 17 is placed onto a shoulder of the holder 18. The holder 18 thus elongates the guiding face 17 slightly downwards. Between the lower end of the holder 18 and the separating metal sheet 25 adjacently opposing below it, a narrow gap-shaped suction opening 23 remains in the elongation of the guiding face 17, through which the auxiliary fluid of the border coat B is sucked away from the curtain V via a suction channel 24 and the fluid outlet 21.

The separating metal sheet 25 is arranged at as small a distance 6 as possible above the surface of the substrate 1. It forms an angle δ₁ relative to the surface of the substrate 1 to be coated and protrudes into the curtain V to a length L. The length L is greater than the maximum thickness of the border coat current B. Thus, not only auxiliary fluid is sucked away but also a part of the curtain fluid, the size of which depends on the distance K which results between the separating edge of the separating metal sheet 25 and the border coat B at the height of the separating edge. The distance K is advantageously minimized specifically for each specific application. Typical values for K are in the range of 1 to 5 mm. The thickness of the separating metal sheet 25 is selected to be as thin as possible in order to minimize braking effects in the curtain current V, and selected to be as thick as is necessary in order to guarantee the mechanical stability of the separating means. Typical values of the metal sheet thickness are in the range of 0.2 to 1 mm.

The angle δ₁ of the separating metal sheet 25 is advantageously selected such that the curtain fluid detaches from its separating edge cleanly and in particular without wetting and thus contaminating the underside of the separating metal sheet 25. The optimum value of the angle δ₁ depends on the wetting properties between the separating metal sheet 25 and the curtain fluid and on the vertical fall velocity of the curtain current V. The optimum value of the angle δ₁ is in the range of −60° to +60° and is determined for each specific application by experiment. In general, a positive pitch of the separating metal sheet 25 is advantageous, i.e. the separating metal sheet 25 protrudes upwards into the curtain current V, as shown in FIG. 10. It is also advantageous if the separating metal sheet 25 or a differently formed separating means is shaped such that a narrow gap is formed between the underside of the separating metal sheet 25 and the facing surface of the substrate 1, which—viewed from the curtain current V—is constricted as far as a narrowest point which should be in the area of the elongation of the guiding face 17, and from there expands again. In the example embodiment, the gap is constricted at the angle δ₁ and expanded at the angle δ₂, such that the underside of the separating means, and in the example embodiment the entire separating metal sheet 25, have the shape of a spread V.

On the other side of the separating edge of the separating metal sheet 25, the curtain fluid falls onto the substrate to be coated 1, wherein the curtain current V laterally contracts again between the separating edge and the substrate 1, since in this area it is no longer guided. The slight contracting of the curtain V in the lowermost area causes a peripheral bulge on the coated substrate 1. In order that the size of the peripheral bulge can be minimized, the height J of the separating edge over the substrate 1 should be minimized for each specific application. J depends on the length L and the angle δ₁ and on the clear height G of the narrowest point between the substrate 1 and the separating means 25, which in the example embodiment is formed between the substrate 1 and a kink in the separating metal sheet 25. G can in turn depend on the thickness of the point of adhesion of two substrate sections or webs connected to each other, and is set to be sufficiently large that each point of adhesion can pass without contact. Typical values for J are in the range of 1 to 5 mm. The length L is selected such that the auxiliary fluid, even in the event of undulating interferences in the border coat B, and all the curtain fluid which flows downwards at a lower velocity than the fall velocity of the free curtain current V, possibly as a consequence of border coat effects which may not be entirely preventable, is separated and sucked away. This minimizes undesirable peripheral effects during coating (dynamic wetting).

Advantageously, the gap width of the suction opening 23 is likewise specifically optimized for each specific application. The gap width should increase with an increasing viscosity of the curtain fluid and an increasing volume flow of the fluids to be sucked away, i.e. with an increasing length L. Typical values for the gap width of the suction opening 23 are in the range of 0.5 to 2 mm. Devices for generating a constant negative pressure, in particular water-driven or air-driven Venturi nozzles or vacuum fans in combination with a collecting vessel and a sump pump with level monitoring, are suitable as suction sources for removing the auxiliary and curtain fluids.

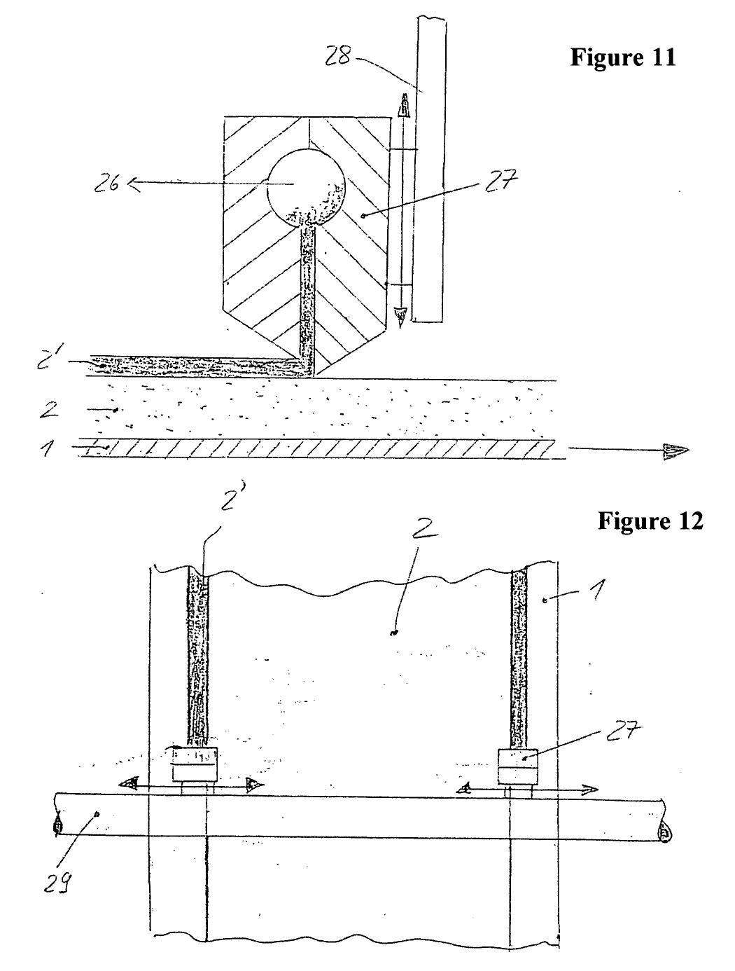

FIGS. 11 and 12 show a third partial system of the side boundary which acts on the already coated substrate 1. The third partial system includes two narrow suction nozzles 27 for sucking away the peripheral bulges 2′ on both sides of the coated substrate. The suction nozzles 27 are mounted between the curtain impact point A (FIG. 9) and the inlet of a subsequent dryer, preferably within the first 500 mm after the curtain impact point A, in order to guarantee that the peripheral bulges are still fluid and thus easy to suck away. The suction nozzles 27 are formed as narrow slit nozzles with an active suction width of their respective suction opening, measured in the conveying direction of the substrate 1, of 5 to 20 mm, preferably 8 to 12 mm. The suction nozzles 27 are connected on one hand to a vacuum source 26, for example air-driven or water-driven Venturi nozzles or vacuum fans in combination with a collecting vessel and a sump pump with level monitoring, and on the other hand are each fed in the immediate vicinity of their nozzle lip with a rinsing fluid, for example water or an organic solvent, which counteracts the risk of blockages.

The suction nozzles 27 are each mounted on a vertical guide 28, vertically adjustable with respect to the coated surface of the substrate, in order that the distance between their nozzle lip and the peripheral bulge can be optimally and precisely set for each application. The vertical guides 28 are mounted on a cross-beam serving as a crossways guide 29, such that their position crossways to the conveying direction of the substrate 1 optimally and precisely matches the position of the peripheral bulges 2′. The optimum position of the suction nozzles 27 is reached when the peripheral bulges are sucked away such that loss of coating crossways to the conveying direction of the substrate 1 is minimized, the remaining bulges are sufficiently dried and winding problems (adhesion or non-uniform hardness of the roll) during winding—if the substrate is a continuously conveyed web—are avoided. Lastly, the vertical guides 28 are mounted on the crossways guide 29 such that they can be removed far enough from the surface of the substrate 1 (50-150 mm), by means of a long-stroke performed by pneumatic cylinders, to enable the suction nozzles 27 to be easily cleaned.

With a view to the specific application in each case, it is also advantageous to decide whether the coated substrate 1 is to be freely suspended or supported, for example by means of the counter roller 3, directly below the suction nozzles 27. If the substrate 1 is freely suspended, the suction output of the suction nozzles 27 is determined less exactly, resulting in the risk of sucking up the substrate 1, although swellings, in particular point of adhesions with an overlap, can pass without the suction nozzles 27 having to be temporarily raised and without the risk of damaging the nozzle lips of the suction nozzles 27. If the substrate 1 is supported by a counter roller 3, then the suction output of the suction nozzles 27 is exactly and reproducibly defined. However, the suction nozzles 27 are advantageously arranged over the surface of the substrate at a sufficiently small distance that thick points of adhesion can only pass if the suction nozzles 27 are temporarily raised. A preferred mounting position for the suction nozzles 27 is in the immediate vicinity of a support, preferably a supporting counter roller 3, in particular in the range of 10 to 50 mm after the point where the substrate 1 detaches from the support 3. This position offers optimum operational conditions with respect to the rigidity of the substrate (suction effect) and the elasticity of the system (passage of points of adhesion).

In the foregoing description, preferred embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1-29. (canceled)

30. A curtain coater for coating a substrate which is moved, comprising:
a nozzle device for generating a curtain of at least one coating fluid falling onto the substrate; and
a curtain guiding structure comprising a guiding face which laterally guides the curtain;
wherein the guiding face is convex to the curtain over a width which, measured crossways to the curtain, exceeds the curtain thickness.

31. The curtain coater according to claim 30, wherein the guiding face is curved crossways to the curtain.

32. The curtain coater according to claim 30, wherein the guiding face is a cylindrical face.

33. The curtain coater according to claim 30, wherein the guiding face forms an arc over its width which exhibits a curvature radius along the arc of at least 5 mm throughout.

34. The curtain coater according to claim 30, wherein the guiding face forms an arc over its width which extends over an arc angle of at least 60° and less than 180°, wherein when the curvature radius is variable along the arc, the arc angle is related to the arithmetical mean curvature radius and, if the curvature radius is constant, is related to said curvature radius.

35. The curtain coater according to claim 30, wherein the guiding face is curved convexly over its width, with a curvature radius of at least 5 mm and at most 50 mm.

36. The curtain coater according to claim 30, wherein the curtain guiding structure comprises a pipe.

37. The curtain coater according to claim 30 further comprising a fluid supply connected to the curtain guiding structure and configured to supply an auxiliary fluid to the guiding face.

38. The curtain coater according to claim 37, wherein the curtain guiding structure has a hollow profile comprising a hollow space and a shell surrounding the hollow space which is permeable to the auxiliary fluid in at least a circumferential segment forming the guiding face.

39. The curtain coater according to claim 38, wherein at least the circumferential segment of the curtain guiding structure consists of a porous material.

40. The curtain coater according to claim 38, wherein the curtain guiding structure is sealed against penetration by the auxiliary fluid at least over a part of the shell that does not form the guiding face.

41. The curtain coater according to claim 37, wherein the auxiliary fluid forms a border coat film which wets the guiding face and exhibits a boarder coat current velocity due to its own weight which corresponds to a fall velocity of the curtain, at least over a large extent of the guiding face.

42. The curtain coater according to claim 38, wherein the curtain guiding structure consists of a porous material which is permeable to the auxiliary fluid and has a wall thickness that varies at least in an area forming the guiding face such that a fall velocity of the auxiliary fluid corresponds to a fall velocity of the curtain.

43. The curtain coater according to claim 30, wherein the curtain guiding structure is supported on a coordinate table such that it can be adjusted relative to the nozzle device.

44. The curtain coater according to claim 30 further comprising a suction means and a separating means protruding into the curtain are provided below the guiding face, in order to capture a fluid flowing down the guiding face over the substrate and to suck away the captured fluid.

45. The curtain coater according to claim 44, wherein a suction opening of the suction means is defined between the separating means and the guiding face or a face of a holder of the guiding face elongating the guiding face.

46. The curtain coater according to claim 44, wherein a gap is defined between the separating means and the substrate, wherein the gap narrows from an inward end of the separating means protruding into the curtain toward a narrowest point and thereafter expands from the narrowest point toward an outward portion of the separating means spaced from the curtain.

47. The curtain coater according to claim 30, wherein the nozzle device comprises:
a nozzle surface inclined to the horizontal;
an exit opening through which the coating fluid can be supplied to the nozzle surface such that the coating fluid forms a downward-flowing film current on the nozzle surface;
a nozzle lip which forms a downstream end of the nozzle surface; and
a nozzle side boundary for laterally restricting the film current.

48. The curtain coater according to claim 47, wherein the nozzle side boundary exhibits a height relative to the nozzle surface, between the nozzle lip and a point upstream of the nozzle lip, which at least substantially corresponds to a respectively local thickness of the film current, such that the film current is prevented from flowing over the nozzle side boundary and coating fluid of the film current is prevented from being drawn up the nozzle side boundary.

49. The curtain coater according to claim 48, wherein the nozzle side boundary exhibits a height relative to the nozzle surface which at least substantially corresponds to a respectively local thickness of the film current, from the exit opening as far as the nozzle lip.

50. The curtain coater according to claim 48, wherein the nozzle device comprises a number of exit openings for coating fluids, in succession in the current direction of the film current, in order to be able to form a multiple-coat film current on the nozzle surface, and wherein the nozzle side boundary exhibits a height relative to the nozzle surface which at least substantially corresponds to a respectively local thickness of the film current from the nozzle lip to at least the most downstream of the exit openings.

51. The curtain coater according to claim 48, wherein the nozzle device comprises a number of exit openings for coating fluids, in succession in the current direction of the film current, in order to be able to form a multiple-coat film current on the nozzle surface, and wherein the nozzle side boundary exhibits a height relative to the nozzle surface which at least substantially corresponds to a respectively local thickness of the film current from the nozzle lip to at least the most upstream of the exit openings.

52. The curtain coater according to claim 47, wherein the nozzle device comprises a fluid supply by means of which an auxiliary fluid can be supplied to the nozzle side boundary in order to form a lubricating film of the auxiliary fluid, which separates the film current from the nozzle side boundary, at least in a longitudinal section of the nozzle side boundary.

53. The curtain coater according to claim 52, wherein the nozzle side boundary comprises a wall structure which is permeable to the auxiliary fluid and connected to the fluid supply.

54. The curtain coater according to claim 53, wherein the permeable wall structure is formed from a porous material.

55. The curtain coater according to claim 52, wherein the lubricating film is formed downstream of the exit opening or a most downstream exit opening of a number of exit openings.

56. The curtain coater according to claim 47, wherein an upper periphery of the nozzle side boundary is formed as an edge with an enclosed edge angle of at most 90°.

57. The curtain coater according to claim 47, wherein an upper periphery of the nozzle side boundary is formed as an edge with an enclosed edge angle of at most 80°.

58. The curtain coater according to claim 56, wherein the edge angle measures at least 30°.

59. The curtain coater according to claim 30, wherein at least one suction nozzle is arranged at at least one of two peripheries of the coated substrate, for sucking away a peripheral bulge of the coating fluid deposited on the substrate.

60. A curtain coating method, comprising:
depositing, in a free-falling manner, a curtain of at least one coating fluid on a moving substrate; and
guiding each side of the curtain with a guiding face which is convex crossways to the curtain.

61. The curtain coating method according to claim 60 further comprising providing an auxiliary fluid along the guiding face.

62. The curtain coating method according to claim 60 further comprising removing a peripheral bulge of the coating fluid from the substrate.
